(19) United States
(12) Patent Application Publication
(10) Pub. No.: US 2025/0371045 A1
(43) Pub. Date: Dec. 4, 2025

(54) QUESTION AND ANSWER INFORMATION TRACING METHOD, DEVICE AND COMPUTER-READABLE MEDIUM

(71) Applicant: Beijing Paoding Technology Co., Ltd., Beijing (CN)

(72) Inventor: Demiao LIN, Beijing (CN)

(21) Appl. No.: 18/830,002

(22) Filed: Sep. 10, 2024

(30) Foreign Application Priority Data
May 30, 2024 (CN) 202410692261.8

(51) Int. Cl. G06F 16/332

(52) U.S. Cl. CPC G06F 16/3329

(57) ABSTRACT

Embodiments of the present disclosure disclose a question and answer information tracing method, equipment and computer-readable medium. A specific mode of implementation of this method includes: generating question and answer information based on question information; displaying the question and answer information; in response to detecting a selection operation applied to any question and answer content in the question and answer information, determining at least one unit question and answer information included in the question and answer content as a target unit question and answer information sequence; for each target unit question and answer information, determining various matching object information corresponding to the target unit question and answer information as a matching object information set; dividing various matching object information sets into matching object information group sets; determining a target matching object information group; displaying a reference source corresponding to the target matching object information group.

### CROSS-REFERENCE TO RELATED APPLICATION

The present application is based on and claims priority from Chinese application number 2024106922618, filed May 30, 2024, the disclosure of which is hereby incorporated by reference herein in its entirety.

### TECHNICAL FIELD

Embodiments of the present disclosure relate to the field of computer technology, specifically to a question and answer information tracing method, equipment and computer-readable medium.

### BACKGROUND

An intelligent question and answer system is an advanced form of information retrieval system, which may accurately and concisely answer questions raised by users in natural languages. At present, when answering the question raised by a user, the usual approach is to provide an answer directly to the user's question, or to generate a citation for the answer directly (for example, similar to citations in papers).

However, inventors have found that when using the above method to provide answers, there are often technical issues such as: the method of directly providing answers cannot verify the reference information of the system generated answers, resulting in users not knowing the authenticity of the answers provided by the system, and when it is necessary to verify the authenticity of some answers, search engines are still needed to supplement the search results, thus leading to poor user experience; the method of directly generating citations for answers has a relatively large granularity of citation and cannot accurately locate to specific positions.

The above information disclosed in this background section is only intended to enhance understanding of the background of the present invention concept, and therefore, it may include information that does not constitute the existing art known to a person having ordinary skill in the art in this country.

### SUMMARY

The content of the present disclosure is intended to briefly introduce concepts, which will be described in detail in the section of detailed description of the invention later. The content of the present disclosure is not intended to identify key or necessary features of the claimed technical solution, nor is it intended to limit the scope of the claimed technical solution.

Some embodiments of the present disclosure propose a question and answer information tracing method, electronic equipment and computer-readable medium to solve one or more of the technical problems mentioned in the background section above.

In the first aspect, some embodiments of the present disclosure provide a method for tracing question and answer information, the method comprising: based on question information entered by a user, generating question and answer information corresponding to the question information, wherein the question and answer information includes a unit question and answer information sequence, each unit question and answer information corresponds to a matching value vector, each matching value in the matching value vector corresponds to matching object information, the matching object information includes a matching object and reference source information corresponding to the matching object, the reference source information includes a reference source identifier and the position information of the matching object in the reference source corresponding to the reference source identifier, and the various matching values in the matching value vector are arranged in a descending order; displaying the question and answer information in a preset position corresponding to the question information in a question and answer window; in response to detecting a selection operation applied to any question and answer content in the question and answer information, determining at least one unit question and answer information included in the question and answer content as a target unit question and answer information sequence, wherein the question and answer content includes at least one unit question and answer information; for each target unit question and answer information in the target unit question and answer information sequence, determining the various matching object information corresponding to the target unit question and answer information as a matching object information set; based on the various reference source information included in the various matching object information sets obtained, dividing the various matching object information sets into matching object information group sets, wherein, the various matching object information in each matching object information group corresponds to the same reference source identifier; determining a target matching object information group; displaying a reference source corresponding to the target matching object information group in a traceability window corresponding to the above question and answer window, wherein, the reference source corresponds to a reference source identifier corresponding to the target matching object information group, and in the displayed reference source, the various matching objects included in the target matching object information group are highlighted.

In the second aspect, some embodiments of the present disclosure provide a device for tracing question and answer information, the device comprising: a generating unit, configured to, based on question information entered by a user, generate question and answer information corresponding to the question information, wherein the question and answer information includes a unit question and answer information sequence, each unit question and answer information corresponds to a matching value vector, each matching value in the matching value vector corresponds to matching object information, the matching object information includes a matching object and reference source information corresponding to the matching object, the reference source information includes a reference source identifier and the position information of the matching object in the reference source corresponding to the reference source identifier, and the various matching values in the matching value vector are arranged in a descending order; a first display unit, configured to display the question and answer information in a preset position corresponding to the question information in a question and answer window; a first determination unit, configured to in response to detecting a selection operation applied to any question and answer content in the question and answer information, determine at least one unit question and answer information included in the question and answer content as a target unit question and answer information sequence, wherein the question and answer content includes at least one unit question and answer information; a second determination unit, configured to determine the various matching object information corresponding to the target unit question and answer information as a matching object information set for each target unit question and answer information in the target unit question and answer information sequence; a dividing unit, configured to divide based on various reference source information included in various matching object information sets obtained, the various matching object information sets into matching object information group sets, wherein, the various matching object information in each matching object information group corresponds to the same reference source identifier; a third determination unit, configured to determine a target matching object information group; a second display unit, configured to display a reference source corresponding to the target matching object information group in a traceability window corresponding to the question and answer window, wherein, the reference source corresponds to a reference source identifier corresponding to the target matching object information group, and in the displayed reference source, the various matching objects included in the target matching object information group are highlighted.

In the third aspect, some embodiments of the present disclosure provide an electronic equipment, comprising: one or more processors; a storage device, on which one or more programs are stored, and when one or more programs are executed by one or more processors, the one or more processors implement the method described in any mode of implementation in the first aspect.

In the fourth aspect, some embodiments of the present disclosure provide a computer-readable medium, on which is stored a computer program that implements the method described in any mode of implementation in the first aspect when executed by a processor.

In the fifth aspect, some embodiments of the present disclosure provide a computer program product, comprising a computer program that implements the method described in any mode of implementation in the first aspect when executed by a processor.

The above embodiments of the present application have the following beneficial effects: through the question and answer information tracing method of some embodiments disclosed herein, users may quickly verify the authenticity of answers and accurately locate to specific positions, thus improving the user experience. To be specific, the reason why users are unable to know the authenticity of the answers provided by the system and why the user experience is poor is that: the method of directly providing answers cannot verify the reference information of the system generated answers, resulting in users not knowing the authenticity of the answers provided by the system, and when it is necessary to verify the authenticity of some answers, search engines are still needed to supplement the search results, thus leading to poor user experience; the method of directly generating citations for answers has a relatively large granularity of citation and cannot accurately locate to specific positions. Based on this, some embodiments of the present disclosure provide a method for tracing question and answer information. Firstly, generate question and answer information corresponding to the question information, based on he question information entered by a user, wherein the question and answer information includes a unit question and answer information sequence, each unit question and answer information corresponds to a matching value vector, each matching value in the matching value vector corresponds to matching object information, the matching object information includes a matching object and reference source information corresponding to the matching object, the reference source information includes a reference source identifier and the position information of the matching object in the reference source corresponding to the reference source identifier, and the various matching values in the matching value vector are arranged in a descending order. As a result, answers may be automatically generated based on user questions, and the process of generating answers is recorded with a matching value vector corresponding to each unit question and answer information, each matching value corresponds to matching object information, which may provide reference for tracing evidence. Then, in a preset position corresponding to the question information in a question and answer window, display the question and answer information. Therefore, answers may be displayed on the screen for users to check against the questions asked. Next, in response to detecting a selection operation applied to any question and answer content in the question and answer information, determine at least one unit question and answer information included in the question and answer content as a target unit question and answer information sequence, wherein the question and answer content includes at least one unit question and answer information. On this basis, it is possible to determine part of the question and answer content selected by the user, and determine each fine-grained unit question and answer information included in the question and answer content selected by the user. Secondly, for each target unit question and answer information in the target unit question and answer information sequence, determine the various matching object information corresponding to the target unit question and answer information as a matching object information set. Therefore, the various matching object information matched when generating each fine-grained target unit question and answer information may be determined. Thereafter, based on the various reference source information included in the various matching object information sets obtained, divide the various matching object information sets into matching object information group sets, wherein, the various matching object information in each matching object information group corresponds to the same reference source identifier. Therefore, the matching object information belonging to the same reference source may be divided into the same group. Then, determine a target matching object information group. Therefore, the determined target matching object information group may be the various matching object information in the reference source to be displayed. Lastly, display a reference source corresponding to the target matching object information group in a traceability window corresponding to the question and answer window, wherein, the reference source corresponds to a reference source identifier corresponding to the target matching object information group, and in the displayed reference source, the various matching objects included in the target matching object information group are highlighted. Therefore, matching objects that match the user's selected question and answer content may be highlighted in the traceability window, allowing users to directly view the source of the question and answer content in the traceability window without the need to supplement the search results through search engines that results in a poor user experience. This may enable users to quickly verify the authenticity of answers and accurately locate to specific positions, thus improving the user experience.

### BRIEF DESCRIPTION OF THE DRAWINGS

The above and other features, advantages, and aspects of the embodiments of the present disclosure will become more apparent in conjunction with the accompanying drawings and with reference to the following specific implementations. Throughout the drawings, the same or similar reference signs indicate the same or similar elements. It should be understood that the drawings are schematic, and the components and elements are not necessarily drawn to scale.

FIG. 1 is a flowchart of some embodiments of the method for tracing question and answer information of the present disclosure;

FIG. 2 is a structural diagram of some embodiments of the device for tracing question and answer information of the present disclosure;

FIG. 3 is a structural diagram of the electronic equipment suitable for implementing some embodiments of the present disclosure.

### DETAILED DESCRIPTION OF EMBODIES

Hereinafter, the embodiments of the present disclosure will be described in more detail with reference to the accompanying drawings. Although certain embodiments of the present disclosure are shown in the drawings, it should be understood that the present disclosure may be implemented in various forms, and shall not be construed as being limited to the embodiments set forth herein. On the contrary, these embodiments are provided for a more thorough and complete understanding of the present disclosure. It should be understood that the drawings and embodiments of the present disclosure are used only for illustrative purposes, not to limit the protection scope of the present disclosure.

Besides, it should be noted that, for ease of description, only the portions related to the relevant invention are shown in the drawings. In the case of no conflict, the embodiments in the present disclosure and the features in the embodiments may be combined with each other.

It should be noted that such concepts as “first” and “second” mentioned in the present disclosure are only used to distinguish different devices, modules or units, and are not used to limit the order of functions performed by these devices, modules or units or interdependence thereof.

It should be noted that such adjuncts as “one” and “more” mentioned in the present disclosure are illustrative, not restrictive, and those skilled in the art should understand that, unless the context clearly indicates otherwise, they should be understood as “one or more”.

The names of messages or information exchanged between multiple devices in the embodiments of the present disclosure are only for illustrative purposes, and are not intended to limit the scope of these messages or information.

Before carrying out such operations as collection, storage and use of user personal information (such as question information) involved in the present disclosure, relevant organizations or individuals shall fulfill their obligations like conducting personal information safety assessments, informing the personal information subject, obtain prior authorization and consent from the personal information subject and so on.

The present disclosure will be described in detail below with reference to the accompanying drawings and in conjunction with embodiments.

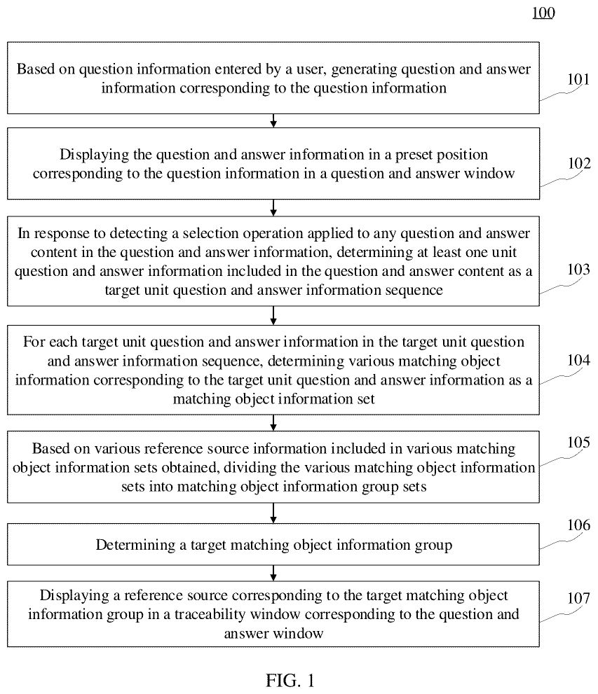

FIG. 1 illustrates a process 100 of some embodiments of the method for tracing question and answer information of the present disclosure. The method for question and answer information comprises the following steps:

Step 101, based on question information entered by a user, generating question and answer information corresponding to the question information.

In some embodiments, the executing body (such as a computing device) of the method for tracing question and answer information may generate question and answer information corresponding to the question information entered by a user. Wherein, the question information may be the user input question, the question and answer information may be answers given in response to the question information. The question and answer information includes a unit question and answer information sequence. The unit question and answer information may be indivisible characters or strings. For example, the unit question and answer information may be a character, a word, or a numerical value. Each unit question and answer information corresponds to a matching value vector. The matching value vector may be a vector composed of the matching values between each matching object and the unit question and answer information. The various matching values in the matching value vector are arranged in a descending order. Each matching value in the matching value vector corresponds to matching object information. The matching object information may be information related to the matching object itself and its reference source. The matching object may be an object in the reference source that matches the unit question and answer information. The types of matching objects may be, but are not limited to: characters, words, numerical values, images. The matching object information may include a matching object and reference source information corresponding to the matching object. The reference source information may be information related to the reference source to which the matching object belongs. The reference source information includes a reference source identifier and the position information of the matching object in the reference source corresponding to the reference source identifier. The reference source identifier may characterize the reference source. The types of reference sources may be, but are not limited to: documents, web pages. The formats of documents may include but are not limited to: Word, PDF, Excel, txt.

In practice, the above-mentioned executing body may send question information to the server, enabling the server to generate question and answer information corresponding to the question information through an intelligent question and answer model. The intelligent question answer model may be a large language model. For example, the large language model may be a generative AI model built on a Transformer network. The above-mentioned executing body may be a server or terminal device. Users may enter question information through the question and answer window of a web application, or through the question and answer window of a local application. The question and answer window may be a window used to display the question information entered by the user and the question and answer information replied by the system. The question information and the question and answer information displayed in the question and answer window may be presented in the form of a chat page.

Alternatively, the above question and answer information includes text information. Each unit question and answer information included in the above question and answer content is text characters.

In certain optional implementations of some embodiments, the following steps may be taken to generate question and answer information corresponding to the question information entered by a user:

The first step is to generate a reference fragment information set based on the above question information. Wherein, each reference fragment information in the reference fragment information set corresponds to a reference source identifier and fragment position information. The reference fragment information set includes reference fragment information corresponding to the text type. In practice, intelligent search technology may be used to retrieve various reference fragment information associated with the question information. The reference fragment information may be partial content extracted from a reference source and related to the question information. The fragment position information may be the position information of the reference fragment information in the reference source. For example, when the reference fragment information is a text segment, the position information may be a paragraph identifier.

The second step is to generate question and answer information corresponding to the question information based on the above question information and the above reference fragment information set. In practice, the question information and reference fragment information set may be input into an intelligent question and answer model to obtain question and answer information corresponding to the question information. The intelligent question and answer model may be a large model. For example, the large model may be a generative AI model built on a Transformer network.

The third step is, for each text character included in the above question and answer information, to perform the following steps:

The first sub-step is to generate an initial matching value vector in response to determining that the above text character is not the first character in the question and answer information based on the question information, the reference fragment information set and the text character preceding the above text character in the question and answer information. Wherein, the matching object corresponding to the matching value in the initial matching value vector mentioned above includes a matching word. In practice, when the above text character is the first character in the question and answer information, the text character preceding the above text character in the question and answer information may be a null value.

The second sub-step is to arrange the various matching values in the initial matching value vector in a descending order, and obtain a descending matching value vector.

The third sub-step is to determine the preset initial value as a cumulative matching value, wherein, the preset initial value may be 0.

The fourth sub-step is to determine the first matching value in the descending matching value vector as a target matching value.

The fifth sub-step is, based on the cumulative matching value and the target matching value, to perform the following cyclic steps:

Firstly, determine the sum of the cumulative matching value and the target matching value as a cumulative matching value, in order to update the cumulative matching value.

Secondly, in response to determining that the updated cumulative matching value is greater than a preset matching threshold, concatenate the target matching value and the various matching values before the target matching value in the descending matching value vector into a filtered matching value vector. For example, the preset matching threshold may be 0.9. Therefore, the various matching values in the descending matching value vector with previous cumulative sums exceeding the preset matching threshold may be filtered out.

Thirdly, in response to the determination that the cumulative matching value updated is less than or equal to the preset matching threshold, the next matching value of the target matching value in the descending matching value vector is determined as the target matching value, in order to update the target matching value, and based on the updated cumulative matching value and the updated target matching value, the above cycle steps are executed again.

The sixth sub-step is to generate a matching value vector and various matching object information corresponding to the text character based on the filtered matching value vector concatenated above. Therefore, the various matching values being filtered out may be used to determine the matching value vector and various corresponding matching object information.

Alternatively, the above question and answer information may be obtained by inputting the above question information into a pre-trained intelligent question and answer model. The intelligent question and answer model may be a generative AI model built on a Transformer network. The intelligent question and answer model includes various decoding layers. Each decoding layer includes various attention layers. Each attention layer is used to generate an attention value vector corresponding to text characters based on question information, reference fragment information sets, and text characters. The attention value vector may be, when generating a text character, a vector of attention scores generated for the question information, reference fragment information set, and all text characters preceding the said text character, and may represent all the information sources required to generate the said text character.

Alternatively, the above-mentioned executing body may also determine the received question and answer information sent by the server corresponding to the question information as the question and answer information to be restored. Then, a pre-trained intelligent question and answer model stored locally may be used to restore the question and answer information to be restored for the above question information. During the restoration process, the matching value vectors of various text characters and the various matching object information in the question and answer information to be restored may be recorded. Therefore, the application scenarios of question and answer tracing may be extended, even if the intelligent question and answer model stored on the server does not have refined question and answer tracing, it may still achieve fine-grained question and answer tracing locally.

In certain optional implementations of some embodiments, the following steps may be taken to generate an initial matching value vector based on the above question information, reference fragment information set and the text character preceding the above text character in the question and answer information:

The first step is to determine the decoding layer corresponding to a preset number of layers in each decoding layer as a target decoding layer. The preset number of layers may be set in advance.

The second step is to determine the various attention layers included in the target decoding layer as a target attention layer set.

The third step is to generate an initial matching value vector based on the various attention value vectors corresponding to the text characters and generated by various target attention layers in the target attention layer set. In practice, the mean vector corresponding to the various attention value vectors may be determined as an initial matching value vector.

In certain optional implementations of some embodiments, the following steps may be taken to generate a matching value vector corresponding to the above text characters and various matching object information based on the filtered matching value vector concatenated above:

The first step is to determine the number of various matching values included in the filtered matching value vector as the number of matches.

The second step is, in response to determining that the number of matches mentioned above is greater than a preset number, to extract by a preset extraction method the preset number of matching values from the filtered matching value vector as the matching value vector corresponding to the text characters mentioned above. Wherein, the preset number may be 10. The preset extraction method may be sequential extraction from front to back. Therefore, the number of filtered matching objects corresponding to the text characters may be limited to a preset number.

The third step is, for each matching value in the matching value vector, to perform the following steps:

The first sub-step is to determine the matching object corresponding to the matching value.

The second sub-step is to determine the reference fragment information to which the determined matching object belongs as the target reference fragment information.

The third sub-step is to determine the reference source identifier of the reference source corresponding to the target reference fragment information.

The fourth sub-step is to determine the position information of the determined matching object in the reference source corresponding to the reference source identifier. When the matching object is a text, the positional information may include paragraph numbers and character arrangement numbers corresponding to the paragraph numbers, for locating the position of the matching object in the reference source.

The fifth sub-step is to determine the determined reference source identifier and position information as the reference source information.

The sixth sub-step is to determine the determined matching object and reference source information as the matching object information corresponding to the above matching value. Therefore, the various determined matching object information may serve as various evidence information for generating the text character.

Alternatively, the above reference fragment information set may include reference fragment information corresponding to the image type. The reference fragment information corresponding to the image type may be an image. To be specific, the reference fragment information corresponding to the image type may be a full page image.

In certain optional implementations of some embodiments, the following steps may be taken to generate question and answer information corresponding to the question information based on the question information and the reference fragment information set:

The first step is to perform the following steps for each reference segment information of the corresponding image type included in the reference fragment information set:

The first sub-step is to segment the reference segment information and obtain various image blocks. In practice, the reference segment information may be segmented according to preset row and column information to obtain various image blocks. For example, the preset row and column information may be 3 rows and 3 columns, then the segmented image blocks may be 3 rows and 3 columns.

The second sub-step is to perform the following steps for each of the various image blocks:

Firstly, perform feature extraction processing on the image blocks to obtain an image block feature vector. In practice, convolutional neural networks may be used to extract features from the image blocks to obtain an image block feature vector.

Secondly, determine the image position of the image blocks in the reference segment information. The image position may be indicated by row and column numbers.

Thirdly, encode the image positions to obtain an image position encoding vector. For example, the encoding method may be binary encoding.

Fourthly, determine the image block feature vector and the image position encoding vector as the image block information.

The third sub-step is to determine the various determined image block information as the reference segment information, to update the reference segment information.

The second step is to generate question and answer information corresponding to the question information based on the question information and the updated reference fragment information set. In practice, the specific method of generating question and answer information corresponding to the question information based on the question information and the updated reference fragment information set may refer to the specific implementation method of “generating question and answer information corresponding to the question information based on the question information and the reference fragment information set”, which will not be repeated here. Therefore, images may also serve as evidence information for text characters that generate question and answer information.

In certain optional implementations of some embodiments, the following steps may be taken to display the reference source corresponding to the target matching object information group in the traceability window corresponding to the above question and answer window:

In response to determining the various matching objects in the target matching object information group including matching objects of corresponding image block types, and for the matching objects of corresponding image block types in the various matching objects, perform the following steps:

The first step is to determine the reference fragment information corresponding to the matching object as the target reference fragment information.

The second step is to determine the image position of the image blocks corresponding to the matching objects in the target reference segment information as the positioning image position.

The third step is to highlight the positioning image position of the target reference segment information in the reference source displayed in the traceability window, so that the image blocks corresponding to the matching objects in the target reference segment information is highlighted. Wherein, the highlight may be a rectangular box.

The reference fragment information and related content of the corresponding image types mentioned above, as an invention point of the embodiments of the present disclosure, solve the technical problem of “when the evidence of the text characters in the generated answer is images, users are less able to verify the authenticity of the answers, and compared to using search engines to search for text on their own, searching for images on their own is more complex, so users have a poorer experience when using an intelligent question and answer system.” The factors that lead to poor user experience when using an intelligent question and answer system are often as follows: when the evidence of the text characters in the generated answers is images, users are less able to verify the authenticity of the answers, and compared to using search engines to search for text on their own, searching for images on their own is more complex. If the above factors are solved, the effect of improving the user experience when using an intelligent question and answer system may be achieved. In order to achieve this effect, the present disclosure when referring to the image type corresponding to the reference fragment information divides the image into various image blocks, extracts image features, and inputs them into an intelligent question and answer model for text character matching. It is also because the matching dimension is based on image blocks, the evidence of the text characters may be generated from this finer-grained dimensional positioning of image blocks, so that when the evidence of the text characters in the generated answer is images, the authenticity of the answer may also be verified, without the need for users to retrieve images themselves, thus improving the user experience when using an intelligent question and answer system.

Step 102, displaying the question and answer information in a preset position corresponding to the question information in a question and answer window.

In some embodiments, the above-mentioned executing body may display the question and answer information in a preset position corresponding to the question information in a question and answer window. Wherein, the preset position may be in the lower left corner. In practice, the executing body may display the question and answer information in a word by word manner in the preset position.

Step 103, in response to detecting a selection operation applied to any question and answer content in the question and answer information, determining at least one unit question and answer information included in the question and answer content as a target unit question and answer information sequence.

In some embodiments, the executing body may in response to detecting a selection operation applied to any question and answer content in the question and answer information, determine at least one unit question and answer information included in the question and answer content as a target unit question and answer information sequence. Wherein, the selection operations may be but are not limited to: click selection operation, box selection operation, and swipe selection operation. For example, the click selection operation may be a double click operation applied to a position in the question and answer information. By double clicking, the term, word, or value at that position may be selected. The box selection operation may be an operation of pulling out a rectangular area to select the unit question and answer information that falls within the rectangular area. The swipe selection operation may be an operation of sequentially swiping the cursor through various characters before one character in the question and answer message. In practice, the executing body may sequentially combine the various unit question and answer information included in the above question and answer content into a target unit question and answer information sequence. When the question and answer content selected by the user includes only one unit question and answer information, the target unit question and answer information sequence only includes one target unit question and answer information.

Step 104, for each target unit question and answer information in the target unit question and answer information sequence, determining the various matching object information corresponding to the target unit question and answer information as a matching object information set.

In some embodiments, the executing body may determine the various matching object information corresponding to the target unit question and answer information as a matching object information set for each target unit question and answer information in the target unit question and answer information sequence. In practice, the executing body may determine the matching value vector corresponding to the target unit question and answer information as a target matching value vector. Then, the various matching object information corresponding to the target matching value vector may be determined as a matching object information set.

Step 105, based on the various reference source information included in the various matching object information sets obtained, dividing the various matching object information sets into matching object information group sets.

In some embodiments, the executing body may divide the various matching object information sets into matching object information group sets based on the various reference source information included in the various matching object information sets obtained. Wherein, the various matching object information in each matching object information group correspond to the same reference source identifier. In practice, the executing body may divide the matching object information with the same reference source identifier in each matching object information set into the same matching object information group, to obtain a matching object information group set.

Step 106, determining a target matching object information group.

In some embodiments, the executing body may determine a target matching object information group. In practice, the executing body may determine the first matching object information group in the matching object information group set as a target matching object information group.

In certain optional implementations of some embodiments, the executing body may determine the target matching object information group by the following steps:

The first step is to determine the first matching object information group in the matching object information group set as a target matching object information group.

The second step is, in response to the detection of a reference source switching operation, based on the target matching object information group, to determine the matching object information group corresponding to the reference source switching operation in the matching object information group set as a target matching object information group, and update the target matching object information group. Wherein, the reference source switching operation may be a selection operation applied to a reference source switching control. The reference source switching control may include a reference source up switching control and a reference source down switching control. The reference source up switching control is used to switch to the previous reference source. The reference source down switching control is used to switch to the next reference source. The reference source switching control may be displayed in the traceability window. In practice, the executing body may respond to determining that the reference source switching operation is a selection operation applied to the reference source down switching control, to determine one matching object information group after the target matching object information group in the matching object information group set as a target matching object information group, and update the target matching object information group. It may be understood that after the target matching object information group is updated, the corresponding reference source is also updated.

The third step is to switch the reference source displayed in the traceability window to a reference source corresponding to the updated target matching object information group. Wherein, in the switched reference source, the various matching objects included in the updated target matching object information group are highlighted.

Step 107, displaying a reference source corresponding to the target matching object information group in a traceability window corresponding to the question and answer window.

In some embodiments, the executing body may display a reference source corresponding to the target matching object information group in a traceability window corresponding to the question and answer window. Wherein, the reference source corresponds to the reference source identifier corresponding to the target matching object information group. In the displayed reference source, the various matching objects included in the target matching object information group are highlighted. For example, the matching objects in a highlighting state may be displayed in a highlighted manner or in a box selection manner.

In certain optional implementations of some embodiments, the executing body may display the reference source corresponding to the target matching object information group in the traceability window corresponding to the question and answer window by the following steps:

The first step is to determine whether there are matching objects included in the target matching object information group in the current traceability page displayed in the aforementioned traceability window.

The second step is, in response to determining that the matching objects included in the target matching object information group exist on the current traceability page displayed in the traceability window, for each matching object included in the target matching object information group that exists on the current traceability page, to highlight the matching objects. Wherein, a matching object switching control is also displayed on the current traceability page. The matching object switching control may be used to switch the selected matching objects. The matching object switching control may include a matching object up switching control and a matching object down switching control. The matching object up switching control is used to switch to the previous matching object. The matching object down switching control is used to switch to the next matching object. The matching object switch control may be displayed in the traceability window. In the initial state, the selected matching object is the first matching object included in the target matching object information group.

The third step is, in response to detecting a selection operation corresponding to the matching object switching control, to determine a switching matching object based on the target matching object information group and the currently selected matching object. In practice, the executing body may respond to determining the selection operation corresponding to the matching object switching control as the selection operation applied to the matching object down switching control, to determine the next matching object of the currently selected matching object in the target matching object information group as a switching matching object.

The fourth step is to locate the current traceability page to the page position corresponding to the switching matching object mentioned above. In practice, the executing body may scroll the current traceability page to the page position corresponding to the switching matching object. The current traceability page may be a web page or a document page. Therefore, the matching object switching control may help users view the various matching objects in a reference source.

Alternatively, in response to determining that the above question and answer content includes at least one sentence, for each sentence in the at least one sentence, the executing body may perform the following steps:

The first step is to determine the various unit question and answer information included in the above sentence as a unit question and answer information set. Here, the sentence may be understood as a string ending with a period.

The second step is to determine the various position information included by the various matching object information corresponding to the unit question and answer information set as a traceability position information set.

The third step is to determine the various paragraph identifiers corresponding to the various traceability position information in the traceability position information set, wherein the paragraph identifiers in the various paragraph identifiers are unique.

The fourth step is to extract the various paragraph contents of the various paragraphs corresponding to the various paragraph identifiers from the reference source corresponding to the matching object information.

The fifth step is, for each paragraph content in the various paragraph contents, to input the paragraph contents and corresponding sentences into a pre-trained traceability relationship recognition model to obtain the traceability relationship between the paragraph contents and the sentences. The traceability relationship recognition model may be a neural network model that takes the text from question and answer information and the text from reference sources as inputs, and the traceability relationship between these two texts as outputs. The traceability relationship may be, but is not limited to: Supportive, Contradictory, or Irrelevant. The Supportive may represent that the text in the reference source may support the generation of text in the question and answer information. The Contradictory may represent that the text in the reference source has a meaning completely opposite to the text in the question and answer information. The Irrelevant may represent that the text in the reference source is irrelevant to the generation of text in the question and answer information. For example, the traceability relationship recognition model may be a Natural Language Inference (NLI) model.

Alternatively, in the displayed reference source, the highlighted state of each matching object included in the target matching object information group corresponds to the target traceability relationship corresponding to the matching object mentioned above. The target traceability relationship is a traceability relationship between the paragraph content where the matching object is located and the sentence where the target unit question and answer information corresponding to the matching object is located. To be specific, when the target traceability relationship is Supportive, the highlighted state of the matching object may be green highlighted. When the target traceability relationship is Contradictory, the highlighted state of the matching object may be red highlighted. When the target traceability relationship is irrelevant, the highlighted state of the matching object may be gray highlighted. Therefore, users may view the relationship between the traceability content and the question and answer content to confirm the supporting relationship between the traceability content and the question and answer content.

The above embodiments of the present application have the following beneficial effects: through the question and answer information tracing method of some embodiments disclosed herein, users may quickly verify the authenticity of answers and accurately locate to specific positions, thus improving the user experience. To be specific, the reason why users are unable to know the authenticity of the answers provided by the system and why the user experience is poor is that: the method of directly providing answers cannot verify the reference information of the system generated answers, resulting in users not knowing the authenticity of the answers provided by the system, and when it is necessary to verify the authenticity of some answers, search engines are still needed to supplement the search results, thus leading to poor user experience; the method of directly generating citations for answers has a relatively large granularity of citation and cannot accurately locate to specific positions. Based on this, some embodiments of the present disclosure provide a method for tracing question and answer information. Firstly, generate question and answer information corresponding to the question information based on the question information entered by a user, wherein the question and answer information includes a unit question and answer information sequence, each unit question and answer information corresponds to a matching value vector, each matching value in the matching value vector corresponds to matching object information, the matching object information includes a matching object and reference source information corresponding to the matching object, the reference source information includes a reference source identifier and the position information of the matching object in the reference source corresponding to the reference source identifier, and the various matching values in the matching value vector are arranged in a descending order. As a result, answers may be automatically generated based on user questions, and the process of generating answers is recorded with a matching value vector corresponding to each unit question and answer information, each matching value corresponds to matching object information, which may provide reference for tracing evidence. Then, in a preset position corresponding to the question information in a question and answer window, display the question and answer information. Therefore, answers may be displayed on the screen for users to check against the questions asked. Next, in response to detecting a selection operation applied to any question and answer content in the question and answer information, determine at least one unit question and answer information included in the question and answer content as a target unit question and answer information sequence, wherein the question and answer content includes at least one unit question and answer information. On this basis, it is possible to determine part of the question and answer content selected by the user, and determine each fine-grained unit question and answer information included in the question and answer content selected by the user. Secondly, for each target unit question and answer information in the target unit question and answer information sequence, determine the various matching object information corresponding to the target unit question and answer information as a matching object information set. Therefore, the various matching object information matched when generating each fine-grained target unit question and answer information may be determined. Thereafter, based on the various reference source information included in the various matching object information sets obtained, divide the various matching object information sets into matching object information group sets, wherein, the various matching object information in each matching object information group corresponds to the same reference source identifier. Therefore, the matching object information belonging to the same reference source may be divided into the same group. Then, determine a target matching object information group. Therefore, the determined target matching object information group may be the various matching object information in the reference source to be displayed. Lastly, display a reference source corresponding to the target matching object information group in a traceability window corresponding to the question and answer window, wherein, the reference source corresponds to a reference source identifier corresponding to the target matching object information group, and in the displayed reference source, the various matching objects included in the target matching object information group are highlighted. Therefore, matching objects that match the user's selected question and answer content may be highlighted in the traceability window, allowing users to directly view the source of the question and answer content in the traceability window without the need to supplement the search results through search engines that results in a poor user experience. This may enable users to quickly verify the authenticity of answers and accurately locate to specific positions, thus improving the user experience.

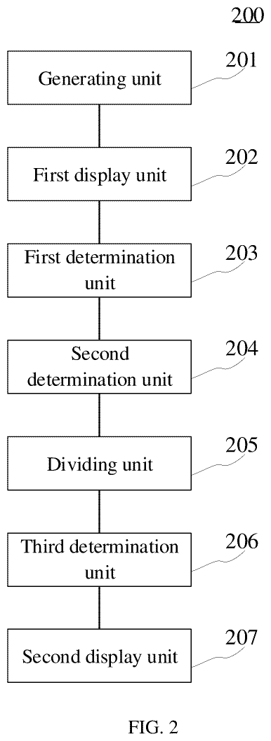

Further referring to FIG. 2, as an implementation of the method shown in the above drawings, the present disclosure provides some embodiments of a device for tracing question and answer information, which correspond to the method embodiments shown in FIG. 1. The device may be specifically applied to various electronic equipment.

As shown in FIG. 2, some embodiments of the device 200 for tracing question and answer information include: a generating unit 201, a first display unit 202, a first determination unit 203, a second determination unit 204, a dividing unit 205, a third determination unit 206, and a second display unit 207. Wherein, the generating unit 201 is configured to based on question information entered by a user, generate question and answer information corresponding to the question information, wherein the question and answer information includes a unit question and answer information sequence, each unit question and answer information corresponds to a matching value vector, each matching value in the matching value vector corresponds to matching object information, the matching object information includes a matching object and reference source information corresponding to the matching object, the reference source information includes a reference source identifier and the position information of the matching object in the reference source corresponding to the reference source identifier, and the various matching values in the matching value vector are arranged in a descending order; the first display unit 202 is configured to display the question and answer information in a preset position corresponding to the question information in a question and answer window; the first determination unit 203 is configured to in response to detecting a selection operation applied to any question and answer content in the question and answer information, determine at least one unit question and answer information included in the question and answer content as a target unit question and answer information sequence, wherein the question and answer content includes at least one unit question and answer information; the second determination unit 204, is configured to determine the various matching object information corresponding to the target unit question and answer information as a matching object information set for each target unit question and answer information in the target unit question and answer information sequence; the dividing unit 205, is configured to divide the various matching object information sets into matching object information group sets based on the various reference source information included in the various matching object information sets obtained, wherein, the various matching object information in each matching object information group corresponds to the same reference source identifier; the third determination unit 206 is configured to determine a target matching object information group; the second display unit 207 is configured to display a reference source corresponding to the target matching object information group in a traceability window corresponding to the question and answer window, wherein, the reference source corresponds to a reference source identifier corresponding to the target matching object information group, and in the displayed reference source, the various matching objects included in the target matching object information group are highlighted.

It should be understood that the various units recorded in the device 200 correspond to the various steps in the method described with reference to in FIG. 1. Therefore, the operations, features, and beneficial effects described above for the method are also applicable to the device 200 and the units comprised therein, and will not be repeated here.

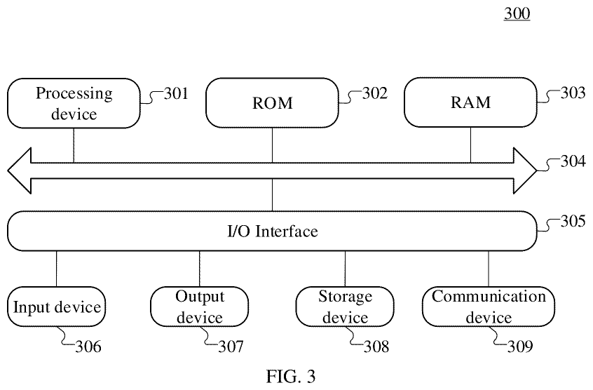

Next, see FIG. 3, which is a structural diagram of the electronic equipment 300 suitable for implementing some embodiments of the present disclosure. The electronic equipment 300 shown in FIG. 3 is only an example and should not impose any limitations on the functionality and scope of use of the embodiments of the present application.

As shown in FIG. 3, the electronic equipment 300 may comprise a processing device 301 (such as a central processing unit, graphics processing unit, etc.) that may perform various appropriate actions and processing based on programs stored in a Read-Only Memory (ROM) 302 or programs loaded from a storage device 308 into a Random Access Memory (RAM) 303. In the RAM 303, various programs and data required for the operation of the electronic equipment 300 are also stored. The processing device 301, ROM 302, and RAM 303 are connected to each other through a bus 304. An input/output (I/O) interface 305 is also connected to the bus 304.

Typically, the following devices may be connected to the I/O interface 305: input devices 306 including, for example, touch screen, touchpad, keyboard, mouse, camera, microphone, accelerometer, gyroscope, etc.; output devices 307 including, for example, Liquid Crystal Display (LCD), speaker, vibrator, etc.; storage devices 308 including, for example, magnetic tape, hard drive, etc.; and a communication device 309. The communication device 309 may allow the electronic equipment 300 to communicate wirelessly or wired with other devices to exchange data. Although FIG. 3 illustrates an electronic equipment 300 with various devices, it should be understood that it is not required to implement or have all the shown devices. It may be implemented or equipped with more or fewer devices as an alternative. Each box shown in FIG. 3 may represent one device or multiple devices as needed.

In particular, according to some embodiments of the present disclosure, the process described above with reference to the flowchart may be implemented as a computer software program. For example, some embodiments of the present disclosure include a computer program product comprising a computer program carried on a computer-readable medium, the computer program including a program code for executing the method shown in the flowchart. In some of such embodiments, the computer program may be downloaded and installed from the network through the communication device 309, or installed from the storage device 308, or installed from the ROM 302. When the computer program is executed by the processing device 301, the above-mentioned functions defined in the method of some embodiments of the present disclosure are executed.

It should be noted that the computer-readable medium recorded in some embodiments of the present disclosure may be a computer-readable signal medium, a computer-readable storage medium, or any combination of the two. A computer-readable storage medium may be, but is not limited to, an electrical, magnetic, optical, electromagnetic, infrared, or semiconductor system, device, or component, or any combination thereof. More specific examples of the computer-readable storage medium may include, but are not limited to: electrical connections with one or more wires, portable computer disks, hard drives, Random Access Memory (RAM), Read-Only Memory (ROM), Erasable Programmable Read-Only Memory (EPROM or flash), fiber optics, portable Compact Disk Read-Only Memory (CD-ROM), optical storage devices, magnetic storage devices, or any suitable combination of the above. In some embodiments of the present disclosure, a computer-readable storage medium may be any tangible medium containing or storing a program, which may be used by an instruction execution system, device, or component, or in combination therewith. In some embodiments of the present disclosure, the computer-readable signal medium may include data signals propagated in the baseband or as part of the carrier wave, carrying a computer-readable program code. This type of propagated data signal may take various forms, including but not limited to electromagnetic signals, optical signals, or any suitable combination of the above. The computer-readable signal medium may also be any computer-readable medium other than a computer-readable storage medium. The computer-readable signal medium may send, propagate, or transmit programs for use by an instruction execution system, device, or component, or in combination therewith. The program code contained on the computer-readable medium may be transmitted using any appropriate medium, including but not limited to: wires, optical cables, RF (radio frequency), etc., or any suitable combination of the above.

In some implementations, clients and servers may communicate using any currently known or future developed network protocol, such as HTTP (HyperText Transfer Protocol), and may interconnect with any form or medium of digital data communication (such as communication networks). Examples of communication networks include Local Area Network (“LAN”), wide area network (“WAN”), internet (for example, the Internet), and end-to-end network (for example, ad hoc end-to-end network), as well as any currently known or future developed networks.

The computer-readable medium may be included in the electronic equipment mentioned above; It may also exist separately without being assembled into the electronic equipment. The computer-readable medium carries one or more programs, and when the one or more programs are executed by the electronic equipment, the electronic equipment is enabled to: based on question information entered by a user, generate question and answer information corresponding to the question information, wherein the question and answer information includes a unit question and answer information sequence, each unit question and answer information corresponds to a matching value vector, each matching value in the matching value vector corresponds to matching object information, the matching object information includes a matching object and reference source information corresponding to the matching object, the reference source information includes a reference source identifier and the position information of the matching object in the reference source corresponding to the reference source identifier, and the various matching values in the matching value vector are arranged in a descending order; display the question and answer information in a preset position corresponding to the question information in a question and answer window; in response to detecting a selection operation applied to any question and answer content in the question and answer information, determine at least one unit question and answer information included in the question and answer content as a target unit question and answer information sequence, wherein the question and answer content includes at least one unit question and answer information; for each target unit question and answer information in the target unit question and answer information sequence, determine the various matching object information corresponding to the target unit question and answer information as a matching object information set; based on the various reference source information included in the various matching object information sets obtained, divide the various matching object information sets into matching object information group sets, wherein, the various matching object information in each matching object information group corresponds to the same reference source identifier; determine a target matching object information group; display a reference source corresponding to the target matching object information group in a traceability window corresponding to the question and answer window, wherein, the reference source corresponds to a reference source identifier corresponding to the target matching object information group, and in the displayed reference source, the various matching objects included in the target matching object information group are highlighted

The computer program code for executing some embodiments of the present disclosure may be written in one or more programming languages or combinations thereof, including object-oriented programming languages such as Java, Smalltalk, C++, and also including existing art procedural programming languages such as C or similar programming languages. The program code may be completely executed on the user's computer, partially executed on the user's computer, executed as an independent software package, partially executed on the user's computer, partially executed on a remote computer, or completely executed on a remote computer or server. In cases involving a remote computer, the remote computer may connect to a user computer through any type of networks, including Local Area Networks (LANs) or Wide Area Networks (WANs), or may connect to external computers (such as using Internet service providers to connect via the Internet).

The flowchart and block diagram in the accompanying drawings illustrate the possible architectures, functions, and operations of the systems, methods, and computer program products according to various embodiments of the present disclosure. At this point, each box in the flowchart or block diagram may represent a module, program segment, or part of code that contains one or more executable instructions for implementing a specified logical function. It should also be noted that in some alternative implementations, the functions indicated in the box may also occur in a different order than those indicated in the accompanying drawings. For example, two consecutive boxes may actually be executed basically in parallel, and sometimes they may also be executed in opposite order, depending on the functionality involved. It should also be noted that each box in the block diagram and/or flowchart, as well as the combination of boxes in the block diagram and/or flowchart, may be implemented using dedicated hardware-based systems that perform specified functions or operations, or may be implemented using a combination of dedicated hardware and computer instructions.

The units described in some embodiments of the present disclosure may be implemented through software or hardware. The described unit may also be set in a processor, for example, be described as: a processor comprising a generating unit, a first display unit, a first determination unit, a second determination unit, a dividing unit, a third determination unit, and a second display unit. Wherein, the names of these units do not constitute limitations on the units themselves in certain situations. For example, the generating unit may also be described as “a unit that generates question and answer information corresponding to the question information entered by a user”.

The functions described above may be at least partially executed by one or more hardware logic components. For example, non-restrictively, exemplary hardware logic components that may be used include: Field Programmable Gate Array (FPGA), Application Specific Integrated Circuit (ASIC), Application Specific Standard Products (ASSP), System on Chip (SOC), Complex Programmable Logic Device (CPLD), and so on.

Some embodiments of the present disclosure also provide a computer program product, comprising a computer program that implements any of the aforementioned question and answer information tracing methods when executed by a processor.

The above description is merely some preferred embodiments of the present disclosure and illustrations of the applied technical principles. Those skilled in the art should understand that the scope of the invention involved in the embodiments of the present disclosure is not limited to the technical solutions formed by the specific combination of the above technical features, but should cover at the same time, without departing from the above inventive concept, other technical solutions formed by any combination of the above technical features or their equivalent features, for example, technical solutions formed by replacing the above features with the technical features of similar functions disclosed in (but not limited to) the embodiments of the present disclosure.

1. A method for tracing question and answer information, comprising:
based on question information entered by a user, generating question and answer information corresponding to the question information, wherein the question and answer information includes a unit question and answer information sequence, each unit question and answer information corresponds to a matching value vector, each matching value in the matching value vector corresponds to matching object information, the matching object information includes a matching object and reference source information corresponding to the matching object, the reference source information includes a reference source identifier and position information of the matching object in the reference source corresponding to the reference source identifier, and various matching values in the matching value vector are arranged in a descending order;
displaying the question and answer information in a preset position corresponding to the question information in a question and answer window;
in response to detecting a selection operation applied to any question and answer content in the question and answer information, determining at least one unit question and answer information included in the question and answer content as a target unit question and answer information sequence, wherein the question and answer content includes at least one unit question and answer information;
for each target unit question and answer information in the target unit question and answer information sequence, determining various matching object information corresponding to the target unit question and answer information as a matching object information set;
based on various reference source information included in various matching object information sets obtained, dividing the various matching object information sets into matching object information group sets, wherein, various matching object information in each matching object information group corresponds to the same reference source identifier;
determining a target matching object information group;
displaying a reference source corresponding to the target matching object information group in a traceability window corresponding to the question and answer window, wherein, the reference source corresponds to a reference source identifier corresponding to the target matching object information group, and in the displayed reference source, various matching objects included in the target matching object information group are highlighted.

2. The method of claim 1, wherein, the question and answer information includes text information, each unit question and answer information included in the question and answer content is text characters; and the generating question and answer information corresponding to the question information includes:
generating a reference fragment information set based on the question information, wherein, each reference fragment information in the reference fragment information set corresponds to a reference source identifier and fragment position information, the reference fragment information set includes reference fragment information corresponding to the text type;
generating question and answer information corresponding to the question information based on the question information and the reference fragment information set;
for each text character included in the question and answer information, performing the following steps:
in response to determining that the text character is not a first character in the question and answer information, generate an initial matching value vector based on the question information, the reference fragment information set and a text character preceding the text character in the question and answer information, wherein, the matching object corresponding to the matching value in the initial matching value vector includes a matching word;
arranging various matching values in the initial matching value vector in the descending order, to obtain a descending matching value vector;
determining a preset initial value as a cumulative matching value;
determining a first matching value in the descending matching value vector as a target matching value;
based on the cumulative matching value and the target matching value, performing the following cyclic steps:
determining a sum of the cumulative matching value and the target matching value as a cumulative matching value, in order to update the cumulative matching value;
in response to determining that the updated cumulative matching value is greater than a preset matching threshold, concatenating the target matching value and various matching values before the target matching value in the descending matching value vector into a filtered matching value vector;
in response to a determination that the cumulative matching value updated is less than or equal to the preset matching threshold, determining the next matching value of the target matching value in the descending matching value vector as the target matching value, in order to update the target matching value, and based on the updated cumulative matching value and the updated target matching value, performing the cyclic steps again;
generating a matching value vector and various matching object information corresponding to the text character based on the filtered matching value vector concatenated.

3. The method of claim 2, wherein, the generating a matching value vector and various matching object information corresponding to the text character based on the filtered matching value vector concatenated includes:
determining a number of various matching values included in the filtered matching value vector as a number of matches;
in response to determining that the number of matches is greater than a preset number, extracting, by a preset extraction method, the preset number of matching values from the filtered matching value vector as the matching value vector corresponding to the text characters;
for each matching value in the matching value vector, performing the following steps:
determining the matching object corresponding to the matching value;
determining the reference fragment information to which the determined matching object belongs, as the target reference fragment information;
determining the reference source identifier of the reference source corresponding to the target reference fragment information;
determining the position information of the determined matching object in the reference source corresponding to the reference source identifier;
determining the determined reference source identifier and position information as the reference source information;
determining the determined matching object and reference source information as the matching object information corresponding to the matching value.

4. The method of claim 2, wherein, the question and answer information is obtained by inputting the question information into a pre-trained intelligent question and answer model, the intelligent question and answer model includes various decoding layers, each decoding layer includes various attention layers, each attention layer is used to generate an attention value vector corresponding to text characters based on the question information, reference fragment information sets, and text characters; and the generating an initial matching value vector based on the question information, the reference fragment information set and the text character preceding the text character in the question and answer information, includes:
determining the decoding layer corresponding to a preset number of layers in the various decoding layers as a target decoding layer;
determining the various attention layers included in the target decoding layer as a target attention layer set;
generating an initial matching value vector based on various attention value vectors corresponding to the text characters and generated by various target attention layers in the target attention layer set.

5. The method of claim 1, wherein, the determining a target matching object information group includes:
determining the first matching object information group in the matching object information group set as a target matching object information group;
in response to the detection of a reference source switching operation, and based on the target matching object information group, determining the matching object information group corresponding to the reference source switching operation in the matching object information group set as a target matching object information group, and updating the target matching object information group;
switching the reference source displayed in the traceability window to a reference source corresponding to the updated target matching object information group, wherein, in the switched reference source, the various matching objects included in the updated target matching object information group are highlighted.

6. The method of claim 1, wherein, the displaying a reference source corresponding to the target matching object information group in a traceability window corresponding to the question and answer window includes:
determining whether there are matching objects included in the target matching object information group in current traceability page displayed in the traceability window;
in response to determining that the matching objects included in the target matching object information group exist in the current traceability page displayed in the traceability window, for each matching object included in the target matching object information group that exists in the current traceability page, highlighting the matching objects, wherein, a matching object switching control is also displayed in the current traceability page;
in response to detecting a selection operation corresponding to the matching object switching control, determining a switching matching object based on the target matching object information group and the currently selected matching object;
locating the current traceability page to a page position corresponding to the switching matching object.

7. (canceled)

8. An electronic equipment, comprising:
one or more processors;
a storage device, on which one or more programs are stored, and
when the one or more programs are executed by the one or more processors, the one or more processors implement the method of claim 1.

9. A non-volatile computer-readable medium, on which a computer program is stored, wherein the computer program when executed by a processor implements the method of claim 1.

10. A computer program product comprising a computer program which, when executed by a processor, implements the method described in any of claim 1.

11. The electronic equipment of claim 8, wherein the question and answer information includes text information, each unit question and answer information included in the question and answer content is text characters; and the generating question and answer information corresponding to the question information includes:
generating a reference fragment information set based on the question information, wherein, each reference fragment information in the reference fragment information set corresponds to a reference source identifier and fragment position information, the reference fragment information set includes reference fragment information corresponding to the text type;
generating question and answer information corresponding to the question information based on the question information and the reference fragment information set;
for each text character included in the question and answer information, performing the following steps:
in response to determining that the text character is not a first character in the question and answer information, generate an initial matching value vector based on the question information, the reference fragment information set and a text character preceding the text character in the question and answer information, wherein, the matching object corresponding to the matching value in the initial matching value vector includes a matching word;
arranging various matching values in the initial matching value vector in the descending order, to obtain a descending matching value vector;
determining a preset initial value as a cumulative matching value;
determining a first matching value in the descending matching value vector as a target matching value;
based on the cumulative matching value and the target matching value, performing the following cyclic steps:
determining a sum of the cumulative matching value and the target matching value as a cumulative matching value, in order to update the cumulative matching value;
in response to determining that the updated cumulative matching value is greater than a preset matching threshold, concatenating the target matching value and various matching values before the target matching value in the descending matching value vector into a filtered matching value vector;
in response to a determination that the cumulative matching value updated is less than or equal to the preset matching threshold, determining the next matching value of the target matching value in the descending matching value vector as the target matching value, in order to update the target matching value, and based on the updated cumulative matching value and the updated target matching value, performing the cyclic steps again;
generating a matching value vector and various matching object information corresponding to the text character based on the filtered matching value vector concatenated.

12. The electronic equipment of claim 11, wherein the generating a matching value vector and various matching object information corresponding to the text character based on the filtered matching value vector concatenated includes:
determining a number of various matching values included in the filtered matching value vector as a number of matches;
in response to determining that the number of matches is greater than a preset number, extracting, by a preset extraction method, the preset number of matching values from the filtered matching value vector as the matching value vector corresponding to the text characters;
for each matching value in the matching value vector, performing the following steps:
determining the matching object corresponding to the matching value;
determining the reference fragment information to which the determined matching object belongs, as the target reference fragment information;
determining the reference source identifier of the reference source corresponding to the target reference fragment information;
determining the position information of the determined matching object in the reference source corresponding to the reference source identifier;
determining the determined reference source identifier and position information as the reference source information;
determining the determined matching object and reference source information as the matching object information corresponding to the matching value.

13. The electronic equipment of claim 11, wherein the question and answer information is obtained by inputting the question information into a pre-trained intelligent question and answer model, the intelligent question and answer model includes various decoding layers, each decoding layer includes various attention layers, each attention layer is used to generate an attention value vector corresponding to text characters based on the question information, reference fragment information sets, and text characters; and the generating an initial matching value vector based on the question information, the reference fragment information set and the text character preceding the text character in the question and answer information, includes:
determining the decoding layer corresponding to a preset number of layers in the various decoding layers as a target decoding layer;
determining the various attention layers included in the target decoding layer as a target attention layer set;
generating an initial matching value vector based on various attention value vectors corresponding to the text characters and generated by various target attention layers in the target attention layer set.

14. The electronic equipment of claim 8 wherein, the determining a target matching object information group includes:
determining the first matching object information group in the matching object information group set as a target matching object information group;
in response to the detection of a reference source switching operation, and based on the target matching object information group, determining the matching object information group corresponding to the reference source switching operation in the matching object information group set as a target matching object information group, and updating the target matching object information group;
switching the reference source displayed in the traceability window to a reference source corresponding to the updated target matching object information group, wherein, in the switched reference source, the various matching objects included in the updated target matching object information group are highlighted.

15. An electronic equipment of claim 8 wherein, the displaying a reference source corresponding to the target matching object information group in a traceability window corresponding to the question and answer window includes:
determining whether there are matching objects included in the target matching object information group in current traceability page displayed in the traceability window;
in response to determining that the matching objects included in the target matching object information group exist in the current traceability page displayed in the traceability window, for each matching object included in the target matching object information group that exists in the current traceability page, highlighting the matching objects, wherein, a matching object switching control is also displayed in the current traceability page;
in response to detecting a selection operation corresponding to the matching object switching control, determining a switching matching object based on the target matching object information group and the currently selected matching object;
locating the current traceability page to a page position corresponding to the switching matching object.

16. The non-volatile computer-readable medium of claim 9 wherein, the question and answer information includes text information, each unit question and answer information included in the question and answer content is text characters; and the generating question and answer information corresponding to the question information includes:
generating a reference fragment information set based on the question information, wherein, each reference fragment information in the reference fragment information set corresponds to a reference source identifier and fragment position information, the reference fragment information set includes reference fragment information corresponding to the text type;
generating question and answer information corresponding to the question information based on the question information and the reference fragment information set;
for each text character included in the question and answer information, performing the following steps:
in response to determining that the text character is not a first character in the question and answer information, generate an initial matching value vector based on the question information, the reference fragment information set and a text character preceding the text character in the question and answer information, wherein, the matching object corresponding to the matching value in the initial matching value vector includes a matching word;
arranging various matching values in the initial matching value vector in the descending order, to obtain a descending matching value vector;
determining a preset initial value as a cumulative matching value;
determining a first matching value in the descending matching value vector as a target matching value;
based on the cumulative matching value and the target matching value, performing the following cyclic steps:
determining a sum of the cumulative matching value and the target matching value as a cumulative matching value, in order to update the cumulative matching value;
in response to determining that the updated cumulative matching value is greater than a preset matching threshold, concatenating the target matching value and various matching values before the target matching value in the descending matching value vector into a filtered matching value vector;
in response to a determination that the cumulative matching value updated is less than or equal to the preset matching threshold, determining the next matching value of the target matching value in the descending matching value vector as the target matching value, in order to update the target matching value, and based on the updated cumulative matching value and the updated target matching value, performing the cyclic steps again;
generating a matching value vector and various matching object information corresponding to the text character based on the filtered matching value vector concatenated.

17. The non-volatile computer-readable medium of claim 16 wherein, the generating a matching value vector and various matching object information corresponding to the text character based on the filtered matching value vector concatenated includes:
determining a number of various matching values included in the filtered matching value vector as a number of matches;
in response to determining that the number of matches is greater than a preset number, extracting, by a preset extraction method, the preset number of matching values from the filtered matching value vector as the matching value vector corresponding to the text characters;
for each matching value in the matching value vector, performing the following steps:
determining the matching object corresponding to the matching value;
determining the reference fragment information to which the determined matching object belongs, as the target reference fragment information;
determining the reference source identifier of the reference source corresponding to the target reference fragment information;
determining the position information of the determined matching object in the reference source corresponding to the reference source identifier;
determining the determined reference source identifier and position information as the reference source information;
determining the determined matching object and reference source information as the matching object information corresponding to the matching value.

18. The non-volatile computer-readable medium of claim 16 wherein, the question and answer information is obtained by inputting the question information into a pre-trained intelligent question and answer model, the intelligent question and answer model includes various decoding layers, each decoding layer includes various attention layers, each attention layer is used to generate an attention value vector corresponding to text characters based on the question information, reference fragment information sets, and text characters; and the generating an initial matching value vector based on the question information, the reference fragment information set and the text character preceding the text character in the question and answer information, includes:
determining the decoding layer corresponding to a preset number of layers in the various decoding layers as a target decoding layer;
determining the various attention layers included in the target decoding layer as a target attention layer set;
generating an initial matching value vector based on various attention value vectors corresponding to the text characters and generated by various target attention layers in the target attention layer set.

19. The non-volatile computer-readable medium of claim 9 wherein, the determining a target matching object information group includes:
determining the first matching object information group in the matching object information group set as a target matching object information group;
in response to the detection of a reference source switching operation, and based on the target matching object information group, determining the matching object information group corresponding to the reference source switching operation in the matching object information group set as a target matching object information group, and updating the target matching object information group;
switching the reference source displayed in the traceability window to a reference source corresponding to the updated target matching object information group, wherein, in the switched reference source, the various matching objects included in the updated target matching object information group are highlighted.

20. The non-volatile computer-readable medium of claim 9 wherein, the displaying a reference source corresponding to the target matching object information group in a traceability window corresponding to the question and answer window includes:
determining whether there are matching objects included in the target matching object information group in current traceability page displayed in the traceability window;
in response to determining that the matching objects included in the target matching object information group exist in the current traceability page displayed in the traceability window, for each matching object included in the target matching object information group that exists in the current traceability page, highlighting the matching objects, wherein, a matching object switching control is also displayed in the current traceability page;
in response to detecting a selection operation corresponding to the matching object switching control, determining a switching matching object based on the target matching object information group and the currently selected matching object;
locating the current traceability page to a page position corresponding to the switching matching object.
